(19) United States
(12) Patent Application Publication
(10) Pub. No.: US 2016/0311695 A1
(43) Pub. Date: Oct. 27, 2016

(54) METHOD FOR REGULATING THE CONCENTRATION OF A TREATMENT CHEMICAL INSIDE A LIQUID BEARING SYSTEM

(71) Applicant: SOLENIS TECHNOLOGIES CAYMAN, L.P., Schaffhausen (CH)

(72) Inventors: Patric Bierganns, Krefeld (DE); Christian Floken, Krefeld (DE); Frank Seida, Werne (DE)

(21) Appl. No.: 15/105,315

(22) PCT Filed: Dec. 29, 2014
(86) PCT No.: PCT/EP2014/079379

§ 371 Date: Jun. 16, 2016

(30) Foreign Application Priority Data
Jan. 3, 2014 (EP) 14150150.2

(51) Int. Cl. C02F 1/00; G01B 17/02; F28F 19/00; G01N 17/00; F28C 1/00; C02F 5/08; G01N 29/04

(52) U.S. Cl. CPC C02F 1/008; C02F 5/08; G01B 17/025; G01N 29/041; G01N 17/008; F28C 1/00; F28F 19/00; C02F 2103/023

(57) ABSTRACT

Provided is a method for regulating the concentration of a treatment chemical inside a liquid bearing system, wherein the presence of the treatment chemical inside the liquid bearing system is defined by an dwell time, wherein the manipulation of the concentration of the treatment chemical inside the liquid bearing system is determined after a time interval, wherein the time interval corresponds to the dwell time.

### TECHNOLOGICAL BACKGROUND

The present invention relates to method for regulating the concentration of a treatment chemical inside a liquid bearing system, in particular in open recirculating cooling water systems. Open recirculating cooling water systems are widely used processes for rejection of waste heat from a variety of industrial processes. Such systems are open as water e.g. evaporates at the cooling tower. In addition, controlled removal of recirculating water is necessary to limit the accumulation of dissolved species that cause corrosion, scaling and fouling. The effluent water is removed with a so-called “blowdown”.

Various additives are on the market that can be added to the recirculating water in order to specifically avoid corrosion, scaling or fouling. These additives are normally added at a rate needed to maintain a relatively constant concentration in the recirculating water. The rate of addition is typically controlled to replace the amount of the additives that are consumed within the recirculating system and that are removed with the blowdown.

However, key operation indicators such as pH value, electrical conductivity, and the like are not directly linked to deposit formation. Even if electrical conductivity and pH value are stable over time, undesired scaling may occur. Ongoing processes may compensate one another.

Furthermore, a sudden change of the pH value, for example, can have various reasons. The pump that supplies acid, base to the recirculating water may be broken, the pH meter may be broken, the storage tank containing acid, base may be empty, and the like. Therefore, a key operation indicator may change for various reasons that all have the same consequence of undesired deposit formation.

US 2010/0176060 and US 2013/0026105 disclose the control of scaling in a cooling water system with CO₂ based upon measurements of the cooling water's pH, alkalinity and Ca²⁺ concentration.

A further problem is that the formation of certain deposits is irreversible. This is particularly the case for scaling. While sophisticated anti-scaling additives are available on the market that are capable of effectively avoiding the deposition of the scaling on surfaces at appropriate dosages, they are usually not capable of removing the scaling once it has been deposited. In consequence, the dosage of anti-scaling additives in the recirculating water is typically kept higher than really necessary in order to avoid scaling formation, just to ensure that no scaling is irreversibly formed.

### SUMMARY OF THE INVENTION

It is object of the present invention to provide a method that reduces the used amount of treatment chemicals inside the liquid bearing system and simultaneously guarantees that corrosion, scaling and/or fouling is restricted or even reduced. In particular there is also demand for providing a method that substantially manipulates the concentration of the treatment chemical inside the liquid bearing system prophylactically in order to avoid the generation of corrosion, scaling and/or fouling from the beginning.

This object is solved by a method for regulating the concentration of a treatment chemical inside a liquid bearing system, wherein the residence of the treatment chemical inside the liquid bearing system is defined by a dwell time and wherein the concentration of the treatment chemical inside the liquid bearing system is manipulated after a time interval correlating to said dwell time.

It is herewith advantageously possible to manipulate the concentration of the treatment chemicals inside the liquid bearing system after each time interval, wherein the time interval corresponds to the dwell time. Preferably the time interval corresponds to a multiple of the dwell time. In particular the current concentration of the treatment chemicals inside the liquid bearing system may be approximated based on the dwell time. Preferably the treatment chemicals comprise an antiscaling product that avoids scaling substantially. Preferably the liquid water system comprises water and/or is an open recirculating cooling water system having an outflow and an inflow preferably. In particular the dwell time is approximated based on basic parameters such as a liquid volume inside the liquid bearing system, evaporation of the liquid and the amount of a blowdown for example. Preferably those basic parameters are known since the operation start of the liquid bearing system or are measured during the operation of the liquid bearing system permanently. It is also thinkable that the dwell time changes during the operation of the liquid bearing system due to long term modifications and consequently the time interval may change correspondingly. In particular it is possible to observe the basic parameters permanently and adapting the time interval every time. In particular the treatment chemicals comprise an antiscaling product, an antifouling product and an anticorrosion product. It is convincible that the treatment chemicals comprise a mixture of the antiscaling product, the antifouling product and the anticorrosion product. Manipulating or changing the concentration of the treatment chemicals inside the liquid bearing system means changing the absolute concentration of the treatment chemicals inside the liquid bearing system as a whole and/or changing the relative concentration of the components of the treatment chemical such as the antiscaling product, the antifouling product and/or the anticorrosion product inside the liquid bearing system respectively.

In another embodiment it is provided that the concentration of the treatment chemical inside the liquid bearing system is manipulated by feeding freshwater and/or treatment chemicals to the liquid bearing system at a feeding rate. It is thinkable that the concentration of treatment chemicals inside the liquid bearing system is changed in a pulsed or continuous form during the time interval, for example the treatment chemical is fed to the liquid bearing system during a short period of the rime interval or it is fed to the liquid bearing system during the whole period of the time interval. In particular the freshwater and/or the treatment chemicals are fed to the liquid bearing system at the beginning of the time interval.

In another embodiment it is provided that the feeding rate of the fresh water and/or the treatment chemical to the liquid bearing system is changed such that the concentration of the treatment chemical in the liquid bearing system is maintained or reduced as long as a key performance indicators signals no scaling, no fouling and/or no corrosion during the time span of at least one time interval. In particular it is provided that the observation of the key performance indicators is in charge of manipulating the concentration inside the liquid bearing system and not a key operation indicator such as pH, conductivity, alkalinity or total hardness. Such key operation indicators may be influenced by a plurality of effects and are not able to signal scaling, fouling and/or corrosion unambiguously. As a result treatment chemicals are reduced till scaling, fouling and/or corrosion is clearly observed. Moreover it is possible to reduce the amount of treatment chemical gradually during the period of several time intervals.

In another embodiment of the present invention it is provided that the feeding rate of the fresh water and/or the treatment chemical to the liquid bearing system is changed such that the concentration of the treatment chemical in the liquid bearing system is increased, preferably as much as possible and/or immediately, as soon as a key performance indicator is observed, wherein the key performance indicator signals scaling, a corrosion and/or a fouling.

In particular it is provided that an antiscaling product is fed to the liquid bearing system. As a result the continuation of scaling is stopped advantageously. It is also thinkable that the concentration of the treatment chemical inside the liquid bearing system is manipulated such that the manipulation of the concentration of the treatment chemical inside the liquid bearing system is equal to a previous manipulation of the concentration of the treatment chemical inside the liquid bearing system. Preferably the feeding rate or dosage of the manipulation is equal to a previous feeding rate or dosage that was used two time intervals before. In particular the manipulation of the concentration of the treatment chemicals occurs asymmetrically, i.e. the concentration of the treatment chemical is reduced gradually as soon as no scaling, no fouling and/or no corrosion is observed, whereas the concentration of the treatment chemicals is changed dramatically as soon scaling, fouling and/or corrosion is observed. This has the advantage that the concentration of the treatment chemical inside the liquid bearing system is manipulated in dependency of its need and is reduced otherwise. As a consequence the needless amount of treatment chemicals fed to the liquid bearing system is reduces advantageously.

In another embodiment it is provided that the concentration of the treatment chemical inside the liquid bearing system is increased as much as needed but as fast as possible for a first period of time, wherein the time interval corresponds to the dwell time and the first period of time lasts a plurality of time intervals. Therefore it is mainly guaranteed that scaling, fouling or corrosion is stopped advantageously. In particular fouling may be reduced.

In another embodiment of the present invention it is provided that the dwell time is based on at least one basic parameter. For example it is provided that at least one basic parameter is monitored during the operation of the liquid bearing system and subsequently the time interval is changed. It is also thinkable that the dwell time is refreshed by calculation or approximation based on modifications that change the liquid bearing system. As a consequence it is advantageously possible to actualize the time interval during the operation of the liquid bearing system. Such an actualization may be necessary because the basic parameters changed due to amendments in the operation of the liquid bearing system. It is also thinkable that the basic parameters changes based on long term modifications inside the liquid bearing system and therefore refreshing the basic parameter has a positive effect. In particular a first dwell time is set during a first global time period, whereas a second dwell time is set during a second global time interval. Preferably the first global time period and the second global time period last for several time intervals. The change from the first global time may be motivated by a variation of the status of the liquid bearing system. For example the blowdown is increased and as the result the second dwell time is adapted to the new status of the liquid bearing system. It is also thinkable that the first dwell time is changed after a further global time period in order to take into account long time modification of the liquid bearing system.

In another embodiment of the present invention it is provided that the liquid bearing system comprises a sensor device, wherein an empirical value is measured by the sensor device and the empirical value is saved in the memory device in combination with at least one parameter of the liquid bearing system, wherein the at least one parameter of the liquid defines the liquid bearing system in the moment of the measurement. For instance the number of time intervals of reducing till scaling occurs is the empirical value. This information may be saved in the memory device in combination with at least one parameter such as temperature or flow velocity of the liquid bearing system. In particular the approximated concentration inside the liquid bearing system may be the at least one parameter. It is also thinkable that the empirical value is saved in combination with a plurality of parameters. Moreover the parameter represents an averaged value that was measured during one or more time intervals. Another empirical value could be the last current concentration of the treatment chemical inside the liquid bearing system approximated before scaling, fouling or corrosion has been signaled. In summery saving the empirical values in the memory device has the advantage of generating a register, wherein the register comprises empirical values for different parameters of the liquid bearing system. Further it is provided that the concentration of the treatment chemical inside the liquid bearing system is manipulated based on the empirical value which are saved in the memory device, whenever the liquid bearing system shows the at least one parameter that is saved in combination with the empirical value. For example the reduction of the concentration of the treatment chemical is stopped after a further number of time intervals, wherein the further number of time intervals is smaller than the number of intervals saved in the memory device. Consequently it is advantageously possible to changes the concentration of the treatment chemical inside the liquid bearing system prophylactically in order to substantially avoid the generation of corrosion, scaling and/or fouling from the beginning.

In another embodiment of the present invention it is provided that the liquid bearing system comprises an analysis unit, wherein an approximated value is provided by the analysis unit based on the saved empirical values. For example the analysis unit interpolates or extrapolates based on the empirical values saved in the memory. As a consequence it is advantageously possible to complete the register that is based on empirical values.

In another embodiment of the present invention it is provided that the concentration of the treatment chemical inside the liquid bearing system is manipulated based on the approximated value. In particular it is herewith advantageously possible to change the concentration of the treatment chemical prophylactically even if the liquid bearing system operates with parameters that are not saved in the memory device.

In another embodiment of the present invention it is provided that deposit is measured by a device comprising an ultrasonic transducer for emitting an ultrasonic emission signal, a detections means for detecting an ultrasonic reflection signal and/or a heating mean. Such a device advantageously detects deposit, in particular scaling, reliably and fast. In particular it is possible to simulate the scaling inside a component of the liquid bearing system by using a heater in combination with the device comprising the ultrasonic transducer in a pipe of the liquid bearing system.

In particular it is provided that the deposit is detected by a device, for detecting deposits in a reflection area inside a liquid-bearing system comprising an ultrasonic transducer for emitting an ultrasonic emission signal towards the reflection area and a first detection means for detecting an ultrasonic reflection signal obtained by reflection of the ultrasonic emission signal in the reflection area, wherein a second detection means is disposed in the reflection area, the second detection means being configured to detect a specific kind of deposit. It is also possible to detect the deposit by a method for detecting fouling and/or scaling deposits in a reflection area inside the liquid-bearing system, comprising a first step of emitting the ultrasonic emission signal towards the reflection area by an ultrasonic transducer, a second step of detecting an ultrasonic reflection signal obtained by reflection of the ultrasonic emission signal in the reflection area by first detection means and a third step of detecting a specific kind of deposit by a second detection means disposed in the reflection area. It is herewith advantageously possible to identify the type or kind or composition of the deposit and subsequently adapt the treatment chemical to the kind of deposit.

In another preferred embodiment it is provided that the deposit formation inside the subsystem is detected by one of the methods disclosed in WO 2009/141 135. Preferably the deposit, i.e. scaling, fouling or corrosion, formation is detected by a method for a high precision measurement of a characteristic of a fouling and/or scaling deposit inside the pipe or of a characteristic of a portion of the wall inside the pipe, wherein an ultrasonic transducer is used, wherein a reflection area is provided in a portion of the wall or attached to a portion of the wall of the fluid vessel at a location substantially opposite of the ultrasonic transducer, wherein the method comprises the steps of: a) emitting an ultrasonic emission signal by means of the ultrasonic transducer and b) measuring the distance between the ultrasonic transducer on the one hand and a fluid/deposit interface or a fluid/wall interface on the other hand in an absolute distance measurement by means of evaluating the time-domain reflective signal of the fluid/deposit or fluid/wall interface, wherein the fluid/deposit or fluid/wall interface is either the interface of the fluid with the deposit on the reflection area or the interface of the fluid with the wall in the reflection area, wherein the time-domain resolution power is 1 ns or less than 1 ns. Preferably the deposit is detected by one of the devices disclosed in WO 2009/141 135. In particular the deposit is detected by a device for a high precision measurement of a characteristic of a fouling and/or scaling deposit inside a fluid vessel or of a characteristic of a portion of the wall inside the pipe, wherein the device comprises an ultrasonic transducer, wherein the device further comprises a reflection area in a portion of the wall or attached to a portion of the wall of the pipe at a location substantially opposite of the ultrasonic transducer, wherein the distance between the ultrasonic transducer on the one hand and a fluid/deposit interface or a fluid/wall interface on the other hand is measured in an absolute distance measurement by means of evaluating the time-domain reflective signal of the fluid/deposit or fluid/wall interface, wherein the fluid/deposit or fluid/wall interface is either the interface of the fluid with the deposit on the reflection area or the interface of the fluid with the wall in the reflection area, wherein the time-domain resolution power of the device is 1 ns or less than 1 ns.

In another preferred embodiment of the present invention it is provided that the deposit inside the subsystem is detected by one of the methods disclosed in WO 2013/092 819. In particular the method for detecting deposit formation comprises a method for detecting and analyzing deposits on the reflecting area, in particular inside the liquid-bearing system, comprising the steps of: emitting the ultrasonic emission signal towards the reflecting area by an ultrasonic transducer in a further first step; detecting an ultrasonic reflection signal obtained by reflection of the ultrasonic emission signal in the area of the reflecting area by detection means in a further second step; determining a distribution of the run time of the detected ultrasonic reflection signal in response to a specified variable in a further third step; analyzing the distribution in a fourth step in order to determine if deposits are deposited at least partially onto the reflecting area. WO 2013/092819 also discloses devices for detecting and analyzing deposits, i.e. fouling, corrosion and/or scaling, in a reflection area. These devices may be attached to the subsystem in order to detect deposit formation. Preferably the device comprises an ultrasonic transducer for emitting an ultrasonic emission signal towards the reflecting area, a detection means for detecting an ultrasonic reflection signal obtained by reflection of the ultrasonic emission signal in the area of the reflecting area and an analyzing unit for determining a distribution of the run time of the detected ultrasonic reflection signal in response to a specified variable and for analyzing the distribution in order to determine if deposits are deposited at least partially onto the reflecting area.

In another particularly preferred embodiment of the present invention the deposit formation is detected by one of the devices disclosed in WO 20131092820. In particular the device for detecting the deposit comprise a device for detecting deposits in a reflecting area inside a liquid-bearing system comprising an ultrasonic transducer for emitting an ultrasonic emission signal towards the reflecting area and a detection means for detecting an ultrasonic reflection signal obtained by reflection of the ultrasonic emission signal in the area of the reflecting area, wherein the device further comprises a heater for increasing the temperature of the reflecting area. WO 2013/092820 also discloses a method for detecting fouling and/or scaling deposits in a reflecting area, in particular inside a liquid-bearing system, comprising a step of emitting an ultrasonic emission signal towards the reflecting area by an ultrasonic transducer and a step of detecting an ultrasonic reflection signal obtained by reflection of the ultrasonic emission signal in the area of the reflecting area by detection means, wherein the temperature of the reflecting area is increased by the heater. Preferably the deposit is measured by one of the methods disclosed in WO 2013/092820.

In another embodiment of the present invention it is provided that the empirical values and the approximated values are refreshed after a second period of time. Due to long term modification inside the liquid bearing system the previously saved empirical values may be no longer valid after the second period of time. Therefore refreshing the empirical values and the approximated values has the advantage of taking long term modification of the liquid bearing system into account.

In another embodiment of the present invention it is provided that the liquid bearing system includes a cooling tower.

In another embodiment of the present invention it is provided that the liquid bearing system is an open recirculating cooling water system having an inflow and an outflow, wherein the concentration of an antiscaling chemical inside the liquid bearing system is manipulated by feeding freshwater and/or the antiscaling chemicals to the liquid bearing system at a feeding rate, wherein scaling is detected by a device for detecting scaling, comprising an ultrasonic transducer for emitting an ultrasonic emission signal, a detection mean for detecting an ultrasonic reflection signal and/or a heating mean, wherein the feeding rate of the fresh water and/or the treatment chemical to the liquid bearing system is changed such that after the time interval, as soon as a scaling is detected by the detection mean, the concentration of the antiscaling chemical inside the liquid bearing system is increased and the feeding rate of the fresh water and/or the treatment chemical to the liquid bearing system is changed such that after a time span of a further time interval, as soon no scaling is detected, the concentration of the antiscaling chemical inside the liquid bearing system is maintained or is reduced, wherein the dwell time is correlated to basic parameters of the outflow and/or the inflow and wherein the time interval is refreshed after a specific number of time intervals.

According to another embodiment of the present invention it is provided that a dosing quantity of the added treatment chemical is constant, whereas the amount of the added freshwater is changed. It is herewith advantageously possible to control the amount of freshwater. In particular freshwater may be saved advantageously. As a consequence of changing the amount of added freshwater the dwell time may be readjusted.

According to an another embodiment of the present invention a method for regulating the concentration of a treatment chemical, preferably an antiscaling chemical, inside a liquid bearing system, preferably an open recirculating cooling water system having an outflow and inflow, is provided, wherein the residence of the treatment chemical inside the liquid bearing system is defined by a dwell time, preferably based on basic parameters of the outflow and/or the outflow, wherein the concentration of the treatment chemical inside the liquid bearing system is manipulated after a time interval correlating to said dwell time, wherein the concentration of the treatment chemical, preferably the antiscaling chemical, inside the liquid bearing system is manipulated by feeding freshwater and/or treatment chemicals to the liquid bearing system at a feeding rate, wherein the feeding rate of the fresh water and/or the treatment chemical to the liquid bearing system is changed such that the concentration of the treatment chemical in the liquid bearing system is increased, preferably as much as possible or corresponding to the manipulation done one or more time intervals ago, as soon as a key performance indicator is observed, wherein the key performance indicator signals deposit formation, preferably scaling, a corrosion and/or a fouling, and wherein the feeding rate of the fresh water and/or the treatment chemical to the liquid bearing system is changed such that the concentration of the treatment chemical in the liquid bearing system is maintained or reduced, preferably gradually and/or slowly, as long as a key performance indicators signals no scaling, no fouling and/or no corrosion during the time span of a further time interval, wherein the further time is a integer multiple of the time interval preferably. In particular the feeding rate to the liquid bearing system is constant during the time interval or an amount of the treatment chemical is fed to the liquid bearing system at a specific point during the time interval. Moreover it is provided that at least one basic parameter is monitored during the operation of the liquid bearing system and subsequently the dwell time and subsequently the time interval is changed. In particular a first dwell time is set during a first global time period, whereas a second dwell time is set during a second global time interval. For example the second dwell time is set as soon as a load is modified, wherein the load classifies the inflow and the outflow of the bearing system substantially. Preferably the second dwell time is set after the amount of added water is changed, wherein the added treatment chemical stays constant. Preferably a deposit such as scaling fouling and/or corrosion, is detected by a device for detecting deposit preferably comprising a mean for emitting an ultrasonic signal and a mean for detecting an ultrasonic signal. In particular the liquid bearing system comprises a memory device, an analyses device and a control unit in order to set the manipulation of the concentration of the treatment chemical inside the liquid bearing system based on empirical values specifying the liquid bearing system. Preferably the empirical values, such as the number of time intervals before deposit formation or the approximated concentration before deposit formation, are used to determinate the feeding rate or the dwell time.

Another subject of the present invention is a liquid bearing system, wherein the liquid bearing system comprises a device for manipulating the concentration of a treatment chemical, wherein the device for manipulating the concentration of the treatment chemical is configured such that the concentration of the treatment chemicals is changeable after a time interval, wherein the time interval corresponds to a dwell time of the treatment chemical of the liquid bearing system. Such a liquid bearing system has the advantage of limiting the amount of treatment chemical. Another subject of the present invention is the use of any one of the methods described above.

Another subject of the present invention is a data processing unit for a liquid bearing system comprising an analysis unit, wherein the analysis unit is configures such that the a dwell time and therefore a time interval for manipulation the concentration of treatment chemicals inside the liquid bearing system, a current concentration of the treatment chemicals inside the liquid bearing system and/or an approximated values based on empirical values are approximated by the analysis unit.

### BRIEF DESCRIPTION OF THE DRAWINGS

FIG. 1 shows schematically a liquid bearing system according to an exemplary first embodiment of the present invention.

FIG. 2 shows a part of a liquid pipe of a liquid bearing system according to an exemplary second embodiment of the present invention.

FIG. 3 shows a block diagram illustrating a third embodiment of the present invention.

### DETAILED DESCRIPTION

The present invention will be descripted with respect to particular embodiments and with the reference to certain drawings but the invention is not limited thereto but only by the claims. The drawings described are only schematic and are non-limiting. In the drawings, the size of some elements may be exaggerated and not drawn on scale for illustrative purposes.

Furthermore, the terms first, second, third and the like in the description and in the claims are used to distinguishing between similar elements and not necessarily for describing a sequential or chronological order. It is to be understood that the terms so used are interchangeable under appropriate circumstances and that the embodiments of the invention described herein are capable of operation in other sequences than described of illustrated herein.

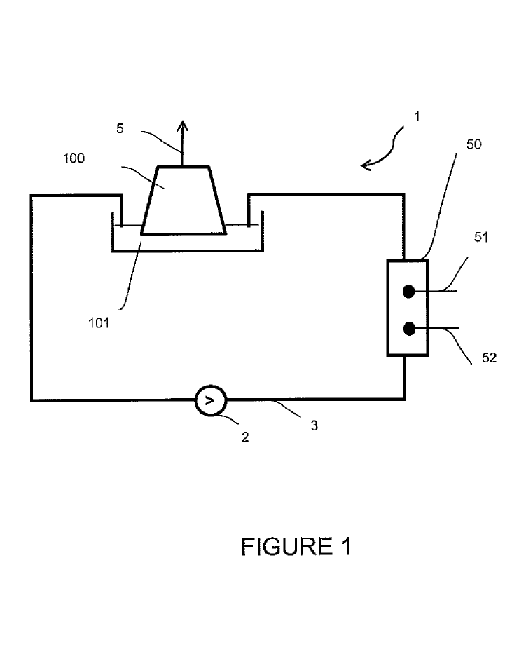

In FIG. 1 a liquid bearing system 1 according to the present invention is illustrated. Such a liquid bearing system 1 usually comprises liquid pipes 3 for transporting a liquid 4 along a transport direction 7. Preferably the liquid 4 is pumped by at least on pumping device 2. Furthermore the liquid bearing system 1 comprises a cooling tower 100 having a tank 101. In particular the liquid bearing system 1 depictured in FIG. 1 is an open recirculating water system. Such systems are open as water e.g. evaporates at the cooling tower. Consequently freshwater is fed to the liquid bearing system 1, preferably through an input, in order to compensate the amount of water that is removed from the liquid bearing system 1 due to evaporation or a blowdown, preferably through an output, for instance. Furthermore adding treatment chemicals to the liquid bearing system 1 is state of the art in order to avoid a scaling, a fouling and/or a corrosion on the inside of the liquid bearing system 1, in particular on the inner surface of the liquid pipes 3, the tank 101 and/or the cooling tower 100. Preferably it is provided that the liquid bearing system 1 comprises a freshwater supply 51 and/or a treatment chemical supply 52, wherein the freshwater supply 51 manipulates the amount of freshwater being fed to the liquid bearing system 1 and the treatment chemical supply 52 manipulates the amount of treatment chemicals being fed to the liquid bearing system 1. It is also conceivable that the liquid bearing system 1 has a premixing chamber 50, wherein the freshwater and the treatment chemical are mixed inside the premixing chamber 50 and subsequently the mixture of freshwater and treatment chemical is fed to the liquid bearing system 1. In particular it is provided that the manipulation of the amount of freshwater, the amount of the treatment chemical or the amount of freshwater and treatment chemical mixed in a specific mixing ratio determinates the concentration of the treatment chemicals inside the liquid bearing system 1. Furthermore the feeding of the liquid bearing system 1 with the freshwater and/or the treatment chemical occurs in a pulsed or continuous form during a specific period of time. In particular it is desirable to add the proper amount of treatment chemicals in order to avoid wasting of treatment chemicals unnecessarily and to limit scaling, fouling and/or corrosion simultaneously. Actually a huge number of parameters influence the scaling and therefore it is difficult to predict the proper amount that is needed in order to limit scaling. For example parameters such as flow velocity, temperature, pressure respectively or the combination of several parameters may lead to scaling. Consequently the proper amount of treatment chemicals is almost unpredictable. According to the present invention a method for regulation the concentration of the treatment chemical inside the liquid bearing system is provided. In particular it is provided that the concentration of the treatment chemical inside the liquid bearing system 1 is manipulated after a time interval that corresponds to a dwell time. Preferably the dwell time is based on basic parameters of the liquid bearing system such as evaporation, blowdown and the circulation of the water inside the liquid bearing system. It is thinkable that those basic parameters are known since the start of the operation of the liquid bearing system 1 or are known from measurements during the operation of the liquid bearing system 1. For example the dwell time t_{1/2} is estimated by

$${t}_{1 / 2} = \frac{{V}_{Sys}}{{\dot{V}}_{Abflut}} \cdot 0.69 = \frac{1000 {m}^{3}}{13 {m}^{3} \text{/} h} \cdot 0.69 = 53.07 h ,$$

wherein V_{Sys} corresponds to the volume of liquid inside the liquid bearing system and \dot{V}_{Abflut} corresponds to the outflow of the liquid leaving the liquid bearing system 1 per time unit. In particular it is provided that the manipulation of the concentration of the treatment chemical inside the liquid bearing system 1 is determined after the time interval that is correlated to the dwell time. Preferably the well time and the time interval are equal and/or the manipulation of the concentration of the treatment chemical is changed such that the concentration of the treatment chemical inside the liquid bearing system 1 is either reduced or increased after the time interval. In particular the concentration of the treatment chemical is increased as soon scaling is detected. Moreover it is provided that the concentration of the treatment chemical inside the liquid bearing system is increased slowly each time interval as long no scaling is detected. Furthermore it is provided that a first dwell time is set for a first global time interval and a second dwell time for a second global time interval.

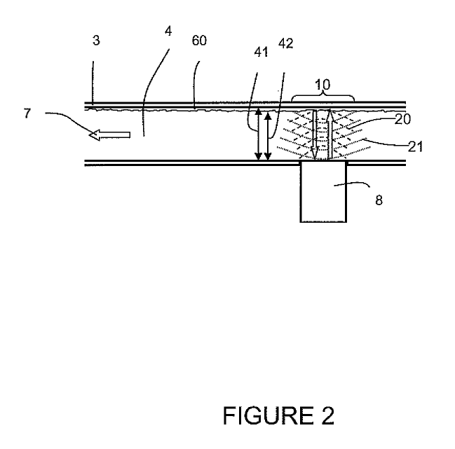

In FIG. 2, a part of a pipe 3 of the liquid bearing system 1 according to the present invention is illustrated. Preferably the pipe 3 has a cylindrical body and the liquid 4 is transported along a transport direction 7. Typically scaling 60 occurs on an inner surface of the pipes 3 of the liquid bearing system 1 and on the inner surfaces of the tank 101 or other components of the liquid bearing system 1. Preferably a device for detecting scale 8 is attached to the pipe 3. In particular the device for detecting scale 8 comprises a mean for emitting an ultrasonic signal and a mean for detecting a reflected ultrasonic signal. Preferably an ultrasonic transducer emits am emitted ultrasonic signal 20, subsequently the emitted ultrasonic signal 20 is transformed to a reflected ultrasonic signal 21 by reflection from a reflection area 10 and finally the ultrasonic signal is detected by the detection mean. Preferably the reflection area 10 is located opposite to the device for detecting scale 8. Based on the travel time of the ultrasonic signal it is possible to measure an effective diameter of the pipe 42, wherein the effective diameter of the pipe is reduced compared to a diameter of the pipe 42 due to the scaling 60. Preferably the device for detecting scale comprises a heater that ensures that the condition in the region of the device for detecting scale corresponds to the condition inside the tank, the cooling tower and/or the other components of the liquid bearing system. As a result the measurement represents the whole liquid bearing system. In particular it is thinkable that the device for detecting scale detects an increase in scaling or a growth of scaling and subsequently the concentration of the antiscaling product inside the liquid bearing system is increased immediately after the time interval.

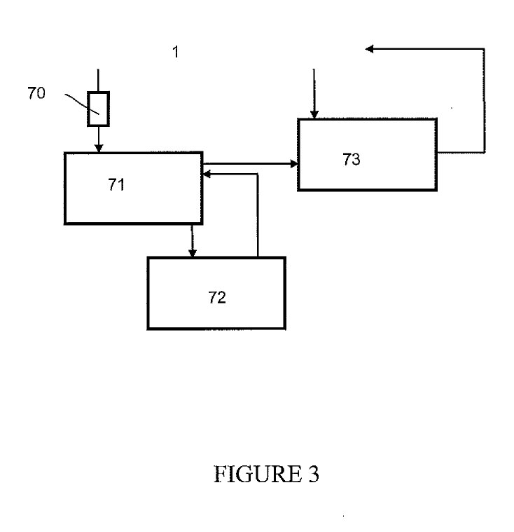

In FIG. 3, a third embodiment of the present invention is shown in a block diagram. According to the third embodiment of the present invention a sensor device 70 triggers a memory device 71 as soon as scaling, fouling or corrosion is detected. The memory device for example saves an empirical value in dependency of a parameter describing the liquid bearing system such as temperature, pressures or flow velocity for example. For example the empirical value is the number of time intervals of reducing the concentration of the treatment chemical inside the liquid bearing system till scaling occurred. A control unit 73 subsequently determinates the reducing of the concentration of the treatment chemical inside the liquid bearing system based on the empirical values as soon as the liquid bearing system is operated having the same parameters measured for the saved empirical value. In particular the reducing of the treatment chemical is stopped at a final time interval before scaling is expected based on the empirical value. It is also thinkable that the liquid bearing system 1 is operated with a different parameter, wherein the different parameter does not correspond to one that was saved in the memory device 71. In such a scenario an analysis device 72 may interpolate between two empirical values or may extrapolates the empirical values saved in the memory device 71 in order to determinate the manipulation of the concentration of the treatment chemical inside the liquid bearing system 1 at the next time interval. It is also conceivable that the senor device measure basic parameters. Such basic parameters may be also saved in the memory device 71 in combination with the parameters of the liquid bearing system 1 and/or a predicted, approximated or calculated concentration of the treatment chemical inside the liquid bearing system 1. In particular the manipulation of the concentration of the treatment chemical is based on the predicted, approximated or calculated concentration of treatment chemicals inside the liquid bearing system. It is also thinkable that the dwell time is defined by the basic parameters. As a consequence the time interval may change during the operation time of the liquid bearing system.

### REFERENCE SIGNS

1 liquid bearing system
2 pumping device
3 liquid pipes
4 liquid
5 evaporation
7 transport direction
8 device for detecting deposit
10 reflection area
20 ultrasonic emission signal
21 ultrasonic reflection signal
41 diameter of the liquid pipe
42 effective diameter of the liquid pipe
50 device for manipulating the concentration inside the liquid bearing system
51 freshwater supply
52 treatment chemical supply
60 scaling
70 sensor device
71 memory device
72 analysis device
73 control unit
100 cooling tower
101 tank

We claim:

1. A method for regulating the concentration of a treatment chemical inside a liquid bearing system, wherein the residence of the treatment chemical inside the liquid bearing system is defined by a dwell time and wherein the concentration of the treatment chemical inside the liquid bearing system is manipulated after a time interval correlating to said dwell time.

2. The method according to claim 1, wherein the concentration of the treatment chemical inside the liquid bearing system is manipulated by feeding freshwater and/or treatment chemicals to the liquid bearing system at a feeding rate.

3. The method according to claim 2, wherein the feeding rate of the fresh water and/or the treatment chemical to the liquid bearing system is changed such that after the time interval, as soon as a scaling, a fouling and/or a corrosion is detected, the concentration of the treatment chemical inside the liquid bearing system is increased as much as needed, wherein the treatment chemical is dosed as fast as possible.

4. The method according to claim 2, wherein the feeding rate of the fresh water and/or the treatment chemical to the liquid bearing system is changed such that after a time span of a further time interval the concentration of the treatment chemical inside the liquid bearing system is maintained or is reduced as soon no scaling, no fouling and/or no corrosion is detected.

5. The method according to claim 3, wherein the time interval corresponds to the dwell time and the concentration of the treatment chemical in the liquid bearing system is increased as much as possible for a first period of time, wherein the first period of time lasts a plurality of time intervals.

6. The method according to claim 1, wherein the dwell time is based on at least one basic parameter.

7. The method according to claim 1, wherein at least one basic parameter is monitored during the operation of the liquid bearing system and subsequently the time interval is changed.

8. The method according to claim 1, wherein the liquid bearing system comprises a sensor device, wherein an empirical value is measured by the sensor device and the empirical value is saved in a memory device in combination with at least one parameter of the liquid bearing system, wherein the at least one parameter of the liquid defines the liquid bearing system in the moment of measurement and, wherein the concentration of the treatment chemical inside the liquid bearing system is manipulated based on the empirical value saved in the memory device whenever the liquid bearing system has the at least one parameter that is saved in combination with the empirical value.

9. The method according to claim 8, wherein the liquid bearing system comprises an analysis unit, wherein an approximated value is provided by the analysis unit based on the saved empirical values, wherein the concentration of the treatment chemical inside the liquid bearing system is manipulated based on the approximated value.

10. The method according to claim 1, wherein a deposit is measured by a device for detecting deposit comprising an ultrasonic transducer for emitting an ultrasonic emission signal, a detections means for detecting an ultrasonic reflection signal and/or a heating mean.

11. The method according to claim 1, wherein the empirical values are refreshed after a second period of time.

12. The method according to claim 1, wherein the liquid bearing system includes a cooling tower.

13. The method according to claim 1, wherein the liquid bearing system is an open recirculating cooling water system having an inflow and an outflow, wherein the concentration of an antiscaling chemical inside the liquid bearing system is manipulated by feeding freshwater and/or the antiscaling chemicals to the liquid bearing system at a feeding rate, wherein scaling is detected by a device for detecting scaling, comprising an ultrasonic transducer for emitting an ultrasonic emission signal, a detection mean for detecting an ultrasonic reflection signal and/or a heating mean,
wherein the feeding rate of the fresh water and/or the treatment chemical to the liquid bearing system is changed such that after the time interval, as soon as a scaling is detected by the detection mean, the concentration of the antiscaling chemical inside the liquid bearing system is increased and
the feeding rate of the fresh water and/or the treatment chemical to the liquid bearing system is changed such that after a time span of a further time interval, as soon as no scaling is detected, the concentration of the antiscaling chemical inside the liquid bearing system is maintained or is reduced, wherein said dwell time is correlated to basic parameters of the outflow and/or the inflow and wherein the time interval is refreshed after a specific number of time intervals.

14. Use of the treatment chemical according to claim 1, for the inhibition of corrosion, scaling or fouling in a recirculating water system.

15. A liquid bearing system comprising a device for manipulating the concentration of a treatment chemical, wherein the device for manipulating the concentration of the treatment chemical is configured such that the concentration of treatment chemicals inside the liquid bearing system is changeable after a time interval, wherein the time interval is correlated to a dwell time.
